(19) United States
(12) Patent Application Publication
(10) Pub. No.: US 2023/0125198 A1
(43) Pub. Date: Apr. 27, 2023

(54) SAW SHEATH

(71) Applicant: U.M. KOGYO INC., HYOGO (JP)

(72) Inventor: SHOZO MIYAWAKI, HYOGO (JP)

(21) Appl. No.: 17/909,634

(22) PCT Filed: Sep. 2, 2020
(86) PCT No.: PCT/JP2020/033237

§ 371 Date: Sep. 6, 2022

(51) Int. Cl. B26B 29/00

(52) U.S. Cl. CPC B26B 29/00

(57) ABSTRACT

A saw sheath is provided which has a simple structure of saw blade guiding means, which can easily and reliably guide a saw blade into a sheath entrance, and which prevents the saw blade from biting into or damaging the sheath entrance. The saw sheath 1 has the saw blade guiding means that guides a saw blade from the sheath entrance 21 to a housing space 11 at rear. The saw blade guiding means includes a pair of shorter-direction-side guide rollers 30 provided on both sides in a longer direction of the sheath entrance 21, a longer-direction-side guide roller 40 provided in an upper portion in front of the sheath entrance 21 to guide the posture of the saw blade in the longer direction of the sheath entrance 21, and a saw blade landing guiding receiver 23 provided in a lower portion in front of the sheath entrance 21 to guide the landing of the saw blade.

### TECHNICAL FIELD

The present invention relates to a saw sheath that houses a blade of a saw.

### BACKGROUND ART

Conventionally, as saw sheaths housing a saw blade of a hand saw or the like, those using guide rollers that guide the saw blade have been provided.

For example, Japanese Utility Model Application Laid-Open No. 7-37585 (Patent Literature 1) discloses a saw sheath provided with a pair of hard roller members (4) on both sides of a saw body insertion opening (3) to guide a saw body (1). Providing the pair of hard roller members (4) exerts the effect that, even if the saw body (1) is inserted somewhat vigorously or roughly, the hard roller members (4) effectively guide the saw body (1) into the saw body insertion opening (3).

PCT International Publication No. WO2012/153398 (Patent Literature 2) discloses a saw sheath which includes: a pair of first guide rollers (11a) provided on both sides in a breadth direction of an entrance of a sheath opening section (10), a pair of second guide rollers (11b), orthogonal to the first guide rollers (11a), provided in the space at the back of the sheath opening section (10), and a pair of third guide rollers (11c), analogous with the first guide rollers (11a), provided further in the back. The second guide rollers (11b) at the back of the sheath opening section (10) serve to guide the saw blade such that its orientation is aligned with the flat direction along the entrance of the sheath body (20).

PCT International Publication No. WO2012/153584 (Patent Literature 3), as with Patent Literature 1 above, discloses a saw sheath (1) provided with a pair of guide rollers (12) on both sides in a breadth direction of an entrance (11) of a sheath opening section (10).

Furthermore, PCT International Publication No. WO2013/014737 (Patent Literature 4) discloses three pairs of guide rollers, as with Patent Literature 2 above.

### CITATION LIST

### Patent Literature

Patent Literature 1: Japanese Utility Model Application Laid-Open No. 7-37585
Patent Literature 2: PCT International Publication No. WO2012/153398
Patent Literature 3: PCT International Publication No. WO2012/153584
Patent Literature 4: PCT International Publication No. WO2013/014737

### SUMMARY OF INVENTION

### Technical Problem

In the invention of Patent Literature 1 above, the pair of hard roller members (4) provided on both sides of the saw body insertion opening (3) make it easier to insert the saw body (1) into the sheath (6), and also prevent biting of the saw blade on the mouth edge on both sides of the saw body insertion opening (3).

However, in the invention of Patent Literature 1, when inserting the saw body (1) into the saw body insertion opening (3), the pair of hard roller members (4) alone are insufficient to guide the posture of the saw body (1) in the flat direction of the saw body insertion opening (3). Further, the saw blade would likely bite into, and cause scratches on, the portions of the mouth edge of the saw body insertion opening (3) where no hard roller member (4) is provided.

In the invention of Patent Literature 2 above, the second guide rollers (11b) at the back of the sheath opening section (10) serve to guide the saw blade such that its orientation is aligned with the flat direction along the entrance of the sheath body (20).

However, the second guide rollers (11b) are installed in the space at the back, which is deeper than the first guide rollers (11a) located at the entrance (14a) of the sheath opening section (10). Such a configuration makes the mounting structure of the second guide rollers (11b) on the sheath complicated in terms of position. Further, since the second guide rollers (11b) are placed deep in the space at the back of the sheath opening section (10), when the saw blade (31) is still near the entrance (14a) of the sheath opening section (10), the rollers cannot sufficiently guide the posture of the saw blade toward the flat direction.

Furthermore, the saw blade (31) can easily bite into, and cause scratches on, the portions of the mouth edge of the entrance (14a) where no first guide roller (11a) is provided, as in the case of the invention of Patent Literature 1 above.

In the invention of Patent Literature 3 above, as in the invention of Patent Literature 1 above, only a pair of guide rollers (12) are provided on both sides of the entrance (11). This pair of guide rollers (12) alone cannot effectively guide the posture of the saw (2) in the flat direction of the entrance (11).

Similarly, the saw blade (41) can easily bite into, and cause scratches on, the portions of the mouth edge of the entrance (11) where no guide roller (12) is provided.

In the invention of Patent Literature 4 above, as in the invention of Patent Literature 2 above, the pair of third guide rollers (11c) that guide the saw blade (31) in the flat direction are provided in a position deeper than the entrance (14a). This leads to a complicated mounting structure. Further, because the third guide rollers (11c) are located deeper than the entrance (14a), it is not possible to sufficiently guide the posture of the saw blade (31) near the entrance in the flat direction. Furthermore, the saw blade (31) can easily bite into, and cause scratches on, the portions of the mouth edge of the entrance (14a) where no first guide roller (11a) is provided.

Therefore, an object of the present invention is to solve various problems of the conventional techniques as described above and to provide a saw sheath which has a simple structure, with no complicated mounting structure for saw blade guiding means near the sheath entrance, which can easily and reliably guide a saw blade into a sheath entrance, and which can also prevent the saw blade from biting and getting stuck in the sheath entrance or damaging the sheath entrance.

### Solution to Problem

To accomplish the above object, a saw sheath of the present invention has a first feature that it has saw blade guiding means that guides a saw blade from a sheath entrance to a housing space at rear, wherein the saw blade guiding means includes: a pair of shorter-direction-side guide rollers provided on both sides in a longer direction of the sheath entrance; a longer-direction-side guide roller provided in an upper portion in front of the sheath entrance to guide a posture of the saw blade in the longer direction of the sheath entrance; and a saw blade landing guiding receiver provided in a lower portion in front of the sheath entrance to guide landing of the saw blade.

Further, the saw sheath of the present invention has, in addition to the first feature described above, a second feature that the longer-direction-side guide roller is attached to an extension made up of an upper side of the sheath entrance extended forward.

Further, the saw sheath of the present invention has, in addition to the first or second feature described above, a third feature that the saw blade landing guiding receiver is made up of a lower side of the sheath entrance extended forward.

Further, the saw sheath of the present invention has, in addition to any of the first through third features described above, a fourth feature that it includes a sloped guide portion in a position at a back of the sheath entrance, the sloped guide portion guiding the saw blade to the housing space narrower than the sheath entrance.

Further, the saw sheath of the present invention has, in addition to any of the first through fourth features described above, a fifth feature that the longer-direction-side guide roller and the saw blade landing guiding receiver are configured to elastically clamp and hold a grip of the saw blade therebetween.

Further, the saw sheath of the present invention has, in addition to the fourth or fifth feature described above, a sixth feature that the sloped guide portion is configured to prevent further penetration of a grip of the saw blade.

### Advantageous Effects of Invention

According to the saw sheath recited in claim 1, the saw blade that has reached the sheath entrance is guided by the pair of shorter-direction-side guide rollers, provided on both sides in the longer direction of the sheath entrance, into between the shorter-direction-side guide rollers. The saw blade is also guided by the longer-direction-side guide roller provided in the upper portion in front of the sheath entrance such that the posture of the saw blade is aligned with the longer direction of the sheath entrance at the position in front of the sheath entrance. Further, with the saw blade landing guiding receiver being provided in the lower portion in front of the sheath entrance, the saw blade lands on, and is guided by, the saw blade landing guiding receiver at the position in front of the sheath entrance.

That is, in front of the sheath entrance, the saw blade lands on the saw blade landing guiding receiver and is also guided by the longer-direction-side guide roller such that its posture is along the longer direction of the sheath entrance, and further, when entering the sheath entrance, the saw blade is guided into the sheath entrance by the pair of shorter-direction-side guide rollers. In other words, the saw blade has its posture smoothly and reliably guided into the sheath entrance by the saw blade guiding means, i.e., the pair of shorter-direction-side guide rollers, the longer-direction-side guide roller, and the saw blade landing guiding receiver.

Since the sheath entrance has no mouth edge into which the saw blade would likely bite, it is possible to reliably prevent the saw blade from biting into or damaging the sheath entrance.

Furthermore, only one longer-direction-side guide roller is used to guide the posture of the saw blade in the longer direction of the sheath entrance, and the roller is located in front of the sheath entrance. This configuration allows smooth and reliable posture control of the saw blade in front of the sheath entrance to guide the saw blade into the sheath entrance, and moreover, it significantly simplifies the structure compared to the conventional mounting structure in which a pair of longer-direction-side guide rollers are mounted in a position deep inside the sheath entrance.

According to the saw sheath recited in claim 2, in addition to the above-described effects obtained by the configuration recited in claim 1, the longer-direction-side guide roller is attached to the extension which is formed by extending forward the upper side of the sheath entrance. The use of the upper side of the sheath entrance facilitates the mounting of the longer-direction-side guide roller, and the structure can be sufficiently simplified compared to the conventional case in which the longer-direction-side guide roller is passed across a position deep inside the sheath entrance.

According to the saw sheath recited in claim 3, in addition to the above-described functions and effects obtained by the configuration recited in claim 1 or 2, the saw blade landing guiding receiver is formed by extending forward the lower side of the sheath entrance. With this configuration, the saw blade can be reliably landed at the position in front of the sheath entrance and can be guided to the sheath entrance.

In addition, eliminating the lower edge of the sheath entrance, which would cause biting of the saw blade, prevents the sheath entrance from being bitten or damaged by the saw blade.

Furthermore, since the saw blade landing guiding receiver is provided on the lower side of the sheath entrance, even though only one longer-direction-side guide roller is installed on the upper side, they work together to smoothly guide the saw blade in the longer direction of the sheath entrance. The saw blade guiding structure can thus be simplified.

According to the saw sheath recited in claim 4, in addition to the above-described functions and effects obtained by the configuration recited in any of claims 1 to 3, the sloped guide portion guiding the saw blade to the housing space narrower than the sheath entrance is provided in a position at the back of the sheath entrance. With this configuration, the saw blade can be smoothly guided from the sheath entrance into the narrower housing space by the sloped guide portion. The saw blade can thus be stored in the narrow housing space inside the sheath without rattling. Moreover, the sheath entrance can be made wider than the housing space at the back, further facilitating the insertion of the saw blade.

According to the saw sheath recited in claim 5, in addition to the above-described functions and effects obtained by the configuration recited in any of claims 1 to 4, it is configured such that the longer-direction-side guide roller and the saw blade landing guiding receiver elastically clamp and hold the grip of the saw blade therebetween. With this configuration, the longer-direction-side guide roller and the saw blade landing guiding receiver as the saw blade guiding means can be used to reliably prevent the saw blade from easily slipping out of the sheath entrance.

According to the saw sheath recited in claim 6, in addition to the above-described functions and effects obtained by the configuration recited in claim 4 or 5, it is configured such that the sloped guide portion prevents further penetration of the grip of the saw blade. With this configuration, the sloped guide portion as the saw blade guiding means can be used to reliably prevent the saw blade from penetrating deeply into the sheath and hitting the bottom of the housing space.

### BRIEF DESCRIPTION OF DRAWINGS

FIG. 1 is a plan view of a saw sheath according to an embodiment of the present invention.

FIG. 2 is a side view of the saw sheath according to the embodiment of the present invention.

FIG. 3 is a perspective view of the saw sheath according to the embodiment of the present invention.

FIG. 4 is a front view of the saw sheath according to the embodiment of the present invention.

FIG. 5 is a perspective view illustrating the function of the saw sheath according to the embodiment of the present invention.

FIG. 6 is a perspective view illustrating the function of a saw sheath according to a comparative example.

### DESCRIPTION OF EMBODIMENTS

A saw sheath according to an embodiment of the present invention will be described below with reference to the drawings.

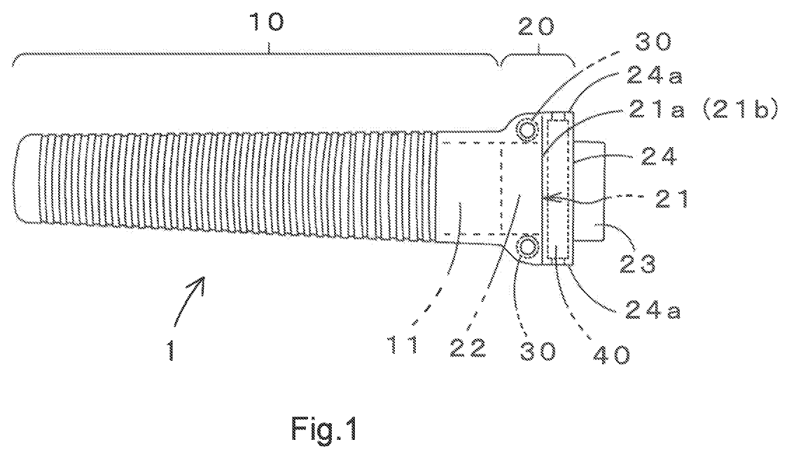

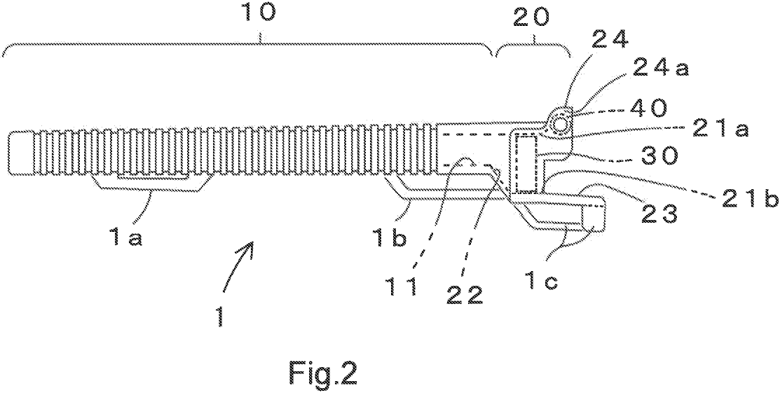

Referring first to FIGS. 1 and 2, a saw sheath 1 includes a body portion 10 and a head portion 20. A saw blade is inserted from a sheath entrance 21 provided in the head portion 20 and stored in a housing space 11 in the body portion 10.

The body portion 10 and the head portion 20 can be provided with wearing attachments 1a, 1b, and 1c for use in wearing the saw sheath 1 on the body of an operator or the like. In the figures, the wearing attachments 1a, 1b, and 1c are provided on the bottom side of the saw sheath 1 (the side to be attached to the operator’s clothing or the like).

The body portion 10 is formed of a flat, elongated cylindrical body, and has its distal end closed if necessary. The length, width, and thickness of the body portion 10 correspond to the length, width, and thickness of the corresponding saw blade.

For the material of the body portion 10, a synthetic resin including a plastic with wood powder, called a wood plastic, or other material can be used.

In the present embodiment, the body portion 10 and the head portion 20 are integrally molded.

The housing space 11 of the body portion 10 is configured as a flat, elongated space suitable for storing the saw blade without rattling.

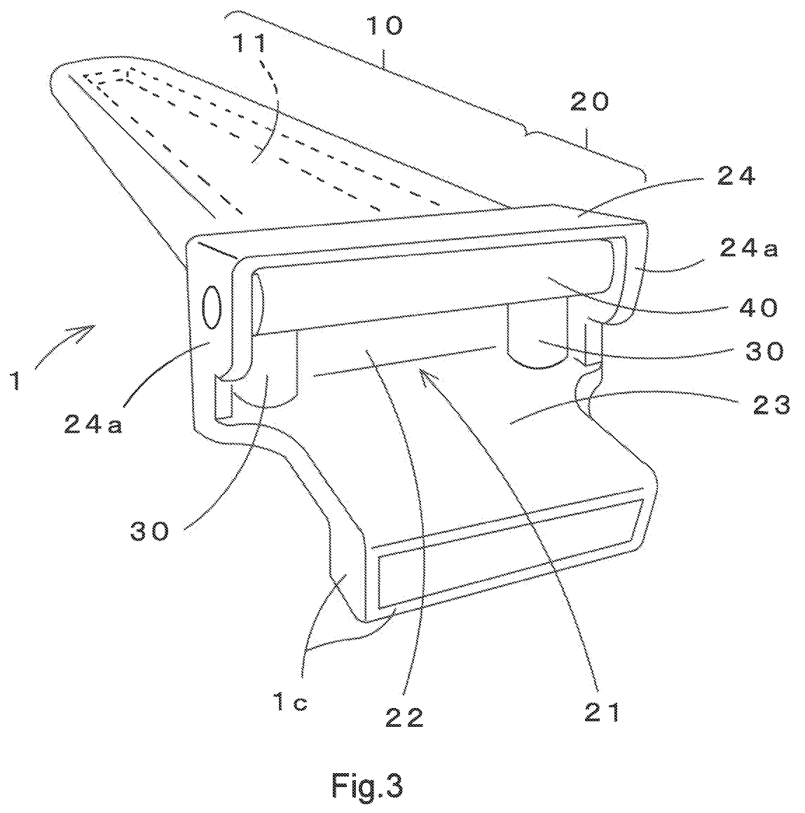

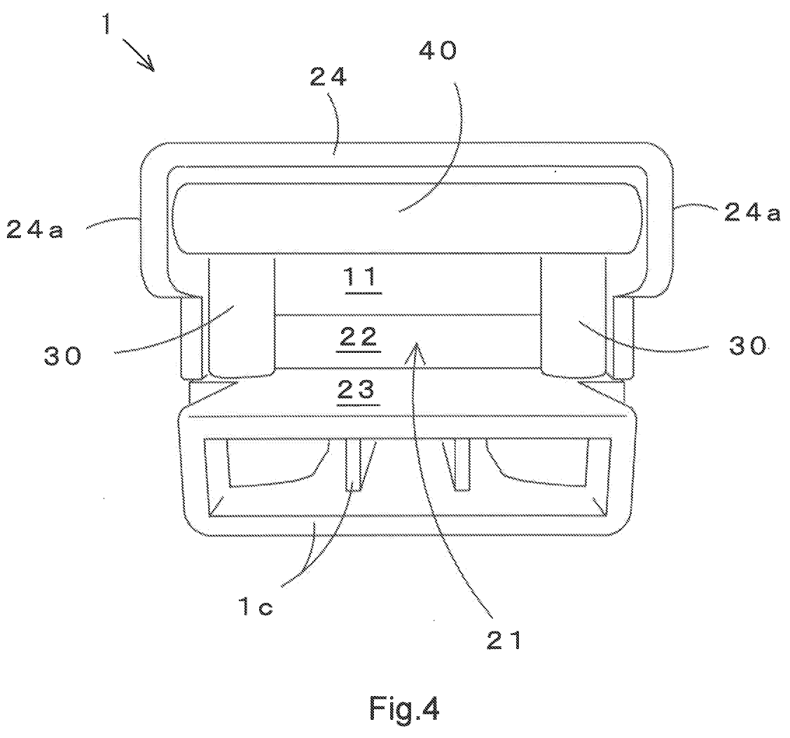

Referring also to FIGS. 3 and 4, the head portion 20 is provided slightly forward of the body portion 10. The head portion 20 is configured to be wider in breadth than the body portion 10. The head portion 20 is also configured to be greater in thickness than the body portion 10.

The head portion 20 is increased in breadth and thickness than the body portion 10 for the purpose of facilitating the insertion of the saw blade.

The head portion 20 is provided with the flat sheath entrance 21. This sheath entrance 21 has a rectangular or nearly rectangular flat shape consisting of a longer direction and a shorter direction. The flat housing space 11, which is even narrower than the sheath entrance 21, is provided at the back of the sheath entrance 21 in communication.

The sheath entrance 21 is configured to have an opening width (in the longer direction) that is larger than an opening width (in the longer direction) of the housing space 11 communicating therewith.

A pair of shorter-direction-side guide rollers 30, 30 are provided on both sides in the longer direction of the sheath entrance 21 (breadth direction of the sheath entrance 21), which are rotatably erected and axially supported in the shorter direction (height direction of the sheath entrance 21).

This pair of shorter-direction-side guide rollers 30, 30 constitute one of the saw blade guiding means that guides the saw blade from the sheath entrance 21 to the rear housing space 11.

The opening width between the shorter-direction-side guide rollers 30 and 30 is a substantial opening width to receive the saw blade. The opening width between the shorter-direction-side guide rollers 30 and 30 is configured to be about the same as an opening width of the housing space 11 which linearly communicates at the back of the sheath entrance 21. This allows the saw blade to be smoothly guided from the sheath entrance 21 to the rear housing space 11 communicating therewith.

The sheath entrance 21 is configured to have an opening whose dimension in the shorter direction is greater than the dimension in the shorter direction of the opening of the housing space 11 communicating at the back of the sheath entrance 21. More specifically, the opening of the insertion opening 21 is configured to be enlarged downwardly in the shorter direction relative to the opening of the housing space 11. In other words, while the housing space 11 has a narrow and flat shape to fit the shape of the saw blade so that the saw blade is tightly housed therein, the sheath entrance 21 has an enlarged opening to facilitate the insertion of the saw blade.

At the back of the enlarged sheath entrance 21, a sloped guide portion 22 is provided.

The sloped guide portion 22 is configured as an ascending slope continuous from the back of the sheath entrance 21 to the housing space 11 side, thereby reducing the dimension in the shorter direction of the sheath entrance 21 toward the housing space 11. That is, the sloped guide portion 22 serves to guide the saw blade that has entered the sheath entrance 21 further into the housing space 11 by making the passage from the sheath entrance 21 continuous to the flatter housing space 11.

The sloped guide portion 22 constitutes one of the saw blade guiding means that guides the saw blade from the sheath entrance 21 to the rear housing space 11.

A longer-direction-side guide roller 40 is provided in an upper portion in front of the sheath entrance 21.

A saw blade landing guiding receiver 23 is provided in a lower portion in front of the sheath entrance 21.

The longer-direction-side guide roller 40 and the saw blade landing guiding receiver 23 are both one of the saw blade guiding means that guides the saw blade.

The pair of shorter-direction-side guide rollers 30, 30, the longer-direction-side guide roller 40, and the saw blade landing guiding receiver 23 constitute a substantial opening of the sheath entrance 21 to receive the saw blade. That is, the saw blade is guided to the sheath entrance 21, with it being surrounded by the longer-direction-side guide roller 40, the saw blade landing guiding receiver 23, and the pair of shorter-direction-side guide rollers 30, 30.

The longer-direction-side guide roller 40 is attached to, and axially supported by, an extension 24 that is a forward extension of an upper side 21a of the sheath entrance 21 provided in the head portion 20 of the saw sheath 1.

The extension 24 is formed by extending the upper side of the sheath entrance 21 forward and also widening it in the shorter direction to secure a mounting space for the longer-direction-side guide roller 40. The extension 24 has mounting side walls 24a, 24a hanging down on both sides in the longer direction of the extension 24 for mounting the longer-direction-side guide roller 40.

The longer-direction-side guide roller 40 is rotatably mounted between the mounting side walls 24a and 24a. The longer-direction-side guide roller 40, when mounted, is positioned immediately in front of the pair of shorter-direction-side guide rollers 30.

The longer-direction-side guide roller 40 is arranged so as to overlap the upper portions of the shorter-direction-side guide rollers 30, 30 in the state of being positioned immediately in front of the shorter-direction-side guide rollers 30, 30.

The longer-direction-side guide roller 40 preferably has a length somewhat longer than a distance between the upright shorter-direction-side guide rollers 30 and 30.

The saw blade landing guiding receiver 23 is formed by extending forward a lower side 21b of the sheath entrance 21 in the head portion 20.

The length of extension of the saw blade landing guiding receiver 23 is made further longer than the position where the longer-direction-side guide roller 40 is positioned. With the saw blade landing guiding receiver 23 being extended further forward than the arrangement position of the longer-direction-side guide roller 40, landing of the saw blade on the saw sheath 1 can be easily received at the saw blade landing guiding receiver 23 first. This facilitates the subsequent saw blade guiding operation.

The saw blade landing guiding receiver 23 preferably has a width equal to or greater than a frontage (separation) between the shorter-direction-side guide rollers 30 and 30. This allows a tip end of the landed saw blade to be easily guided to the sheath entrance 21.

The longer-direction-side guide roller 40 and the saw blade landing guiding receiver 23 are arranged vertically opposing each other in the position extended forward from the sheath entrance 21, so that they can readily guide the posture of the saw blade in the direction along the flat sheath entrance 21.

The longer-direction-side guide roller 40 and the saw blade landing guiding receiver 23 are configured to work together to achieve another functional effect. That is, the longer-direction-side guide roller 40 and the saw blade landing guiding receiver 23 are configured to vertically oppose each other with a dimension slightly narrower than the thickness of a grip (handle) of the saw blade, so that they can elastically clamp and hold the grip (handle) of the inserted saw blade from above and below while accepting the same with the longer-direction-side guide roller 40. This prevents slipping off and rattling of the saw blade housed in the saw sheath 1.

In order to facilitate the elastic clamping and holding of the grip of the saw blade by the longer-direction-side guide roller 40 and the saw blade landing guiding receiver 23, it is preferable that the head portion 20 of the saw sheath 1 including the longer-direction-side guide roller 40 and the saw blade landing guiding receiver 23 is made of a plastic or other material that allows some deformation, or that the grip of the saw blade is made of a rubber or other material that allows elastic deformation.

The sloped guide portion 22 is configured at the back of the sheath entrance 21 and reduces the dimension in the shorter direction of the sheath entrance 21 toward the rear, flatter housing space 11, and serves to guide the saw blade into the less rattling housing space 11.

Another configuration or role of the sloped guide portion 22 is, upon insertion of the saw blade, when the grip (handle) of the saw blade finally enters into the sheath entrance 21, to prevent further penetration of the grip. That is, with the sloped guide portion 22 being provided at the back of the sheath entrance 21, the grip that has penetrated into the sheath entrance 21 immediately before the completion of saw blade insertion is stopped by the sloped guide portion 22, whereby the insertion of the saw blade is completed.

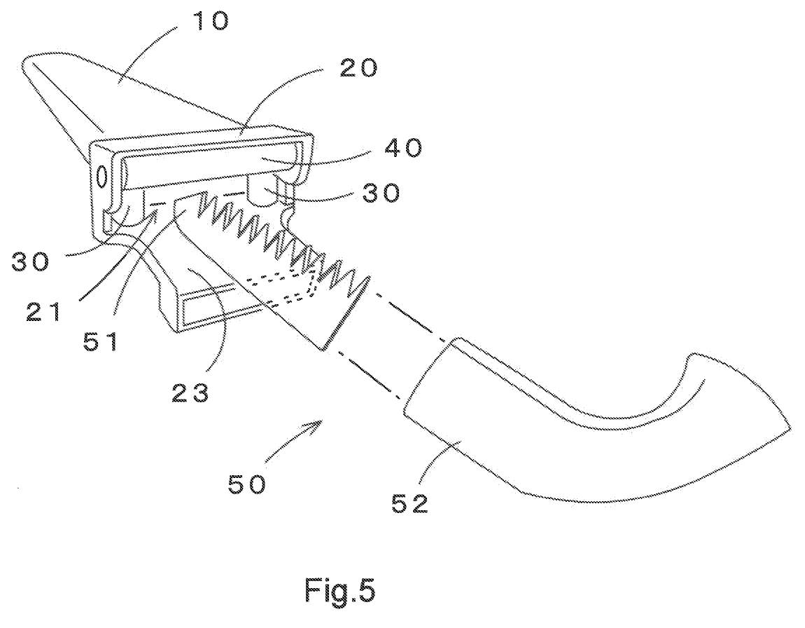

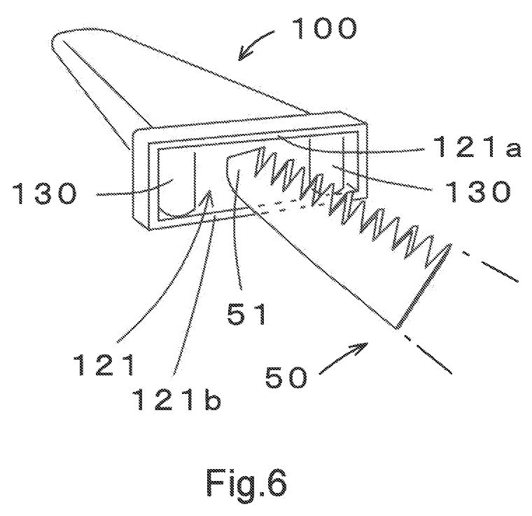

Referring to FIGS. 5 and 6, a description will be made of an operational function of the saw sheath 1 according to the present embodiment, in comparison with a conventional saw sheath.

FIG. 6 shows a conventional saw sheath in which a sheath entrance 121 is provided with only a pair of shorter-direction-side guide rollers 130. A saw blade 50 can easily bite upper and lower edges 121a and 121b of the sheath entrance 121, hindering smooth insertion of the saw blade 50. Further, the upper and lower edges 121a and 121b are prone to damages.

A typical operational action when inserting a saw blade 50 into the saw sheath 1 of the present invention will be described with reference to FIG. 5.

When inserting the saw blade 50 into the saw sheath 1, an operator holds a grip 52 at the proximal end of the saw blade 50 and moves a blade tip 51 of the saw blade 50 toward the sheath entrance 21.

The blade tip 51 of the saw blade 50 first lands on the saw blade landing guiding receiver 23, and then moves on the saw blade landing guiding receiver 23 in the direction of the sheath entrance 21.

At this time, since the posture of the saw blade 50 is not yet completely coincident with the longer direction of the sheath entrance 21, the saw blade 50 will contact the longer-direction-side guide roller 40.

The longer-direction-side guide roller 40 then receives the saw blade 50, while being pushed by the saw blade 50 and rolling to avoid the biting of the saw blade, and guides the posture of the saw blade 50 toward the longer direction.

The saw blade 50 which has reached the sheath entrance 21, with its posture having been guided in the longer direction by the longer-direction-side guide roller 40, is further guided by the pair of shorter-direction-side guide rollers 30, 30 erected on both sides in the longer direction of the sheath entrance 21, and is guided into between the shorter-direction-side guide rollers 30 and 30.

The saw blade 50 that has passed through the sheath entrance 21 is guided sequentially from its blade tip 51 through the sloped guide portion 22 to be stored in the flatter housing space 11.

When the tip end of the grip 52 of the saw blade 50 passes through the sheath entrance 21 and reaches the sloped guide portion 22 at the back, the saw blade 50 is stopped and its further penetration is prevented, whereby the insertion of the saw blade 50 into the saw sheath 1 is completed.

At the time point when the insertion of the saw blade 50 into the saw sheath 1 is completed, the grip 52 of the saw blade 50 is elastically clamped and held between the longer-direction-side guide roller 40 and the saw blade landing guiding receiver 23.

### Industrial Applicability

The saw sheath of the present invention has industrial applicability, together with a saw, as a sheath that houses the saw.

### Reference Signs List

1: saw sheath
1a, 1b, 1c: wearing attachment
10: body portion
11: housing space
20: head portion
21: sheath entrance
21a: upper side
21b: lower side
22: sloped guide portion
23: saw blade landing guiding receiver
24: extension
24a: mounting side wall
30: shorter-direction-side guide roller
40: longer-direction-side guide roller
50: saw blade
51: blade tip
52: grip

1. A saw sheath having saw blade guiding means that guides a saw blade from a sheath entrance to a housing space at rear, the saw blade guiding means comprising:
a pair of shorter-direction-side guide rollers provided on both sides in a longer direction of the sheath entrance;
a longer-direction-side guide roller provided in an upper portion in front of the sheath entrance to guide a posture of the saw blade in the longer direction of the sheath entrance; and
a saw blade landing guiding receiver provided in a lower portion in front of the sheath entrance to guide landing of the saw blade.

2. The saw sheath according to claim 1, wherein the longer-direction-side guide roller is attached to an extension made up of an upper side of the sheath entrance extended forward.

3. The saw sheath according to claim 2, wherein the saw blade landing guiding receiver is made up of a lower side of the sheath entrance extended forward.

4. The saw sheath according to claim 3, comprising a sloped guide portion in a position at a back of the sheath entrance, the sloped guide portion guiding the saw blade to the housing space narrower than the sheath entrance.

5. The saw sheath according to claim 4, configured such that the longer-direction-side guide roller and the saw blade landing guiding receiver elastically clamp and hold a grip of the saw blade therebetween.

6. The saw sheath according to claim 5, configured such that the sloped guide portion prevents further penetration of a grip of the saw blade.

7. The saw sheath according to claim 1, wherein the saw blade landing guiding receiver is made up of a lower side of the sheath entrance extended forward.

8. The saw sheath according to claim 1, comprising a sloped guide portion in a position at a back of the sheath entrance, the sloped guide portion guiding the saw blade to the housing space narrower than the sheath entrance.

9. The saw sheath according to claim 2, comprising a sloped guide portion in a position at a back of the sheath entrance, the sloped guide portion guiding the saw blade to the housing space narrower than the sheath entrance.

10. The saw sheath according to claim 7, comprising a sloped guide portion in a position at a back of the sheath entrance, the sloped guide portion guiding the saw blade to the housing space narrower than the sheath entrance.

11. The saw sheath according to claim 1, configured such that the longer-direction-side guide roller and the saw blade landing guiding receiver elastically clamp and hold a grip of the saw blade therebetween.

12. The saw sheath according to claim 2, configured such that the longer-direction-side guide roller and the saw blade landing guiding receiver elastically clamp and hold a grip of the saw blade therebetween.

13. The saw sheath according to claim 3, configured such that the longer-direction-side guide roller and the saw blade landing guiding receiver elastically clamp and hold a grip of the saw blade therebetween.

14. The saw sheath according to claim 7, configured such that the longer-direction-side guide roller and the saw blade landing guiding receiver elastically clamp and hold a grip of the saw blade therebetween.

15. The saw sheath according to claim 8, configured such that the longer-direction-side guide roller and the saw blade landing guiding receiver elastically clamp and hold a grip of the saw blade therebetween.

16. The saw sheath according to claim 9, configured such that the longer-direction-side guide roller and the saw blade landing guiding receiver elastically clamp and hold a grip of the saw blade therebetween.

17. The saw sheath according to claim 4, configured such that the sloped guide portion prevents further penetration of a grip of the saw blade.
